(19) United States
(12) Patent Application Publication
(10) Pub. No.: US 2024/0416484 A1
(43) Pub. Date: Dec. 19, 2024

(54) CAVITATION PROCESSING METHOD

(71) Applicant: SUGINO MACHINE LIMITED, Namerikawa City (JP)

(72) Inventor: Hideaki SAKAI, Namerikawa City (JP)

(21) Appl. No.: 18/676,368

(22) Filed: May 28, 2024

(30) Foreign Application Priority Data
Jun. 15, 2023 (JP) 2023-098400

(51) Int. Cl. B24C 1/10

(52) U.S. Cl. CPC B24C 1/10

(57) ABSTRACT

An object of the present invention is to provide a cavitation processing method for performing the cavitation processing on a side surface of an target hole of an workpiece. The cavitation processing method, includes: immersing a workpiece and a nozzle in a processing liquid, the workpiece having a target hole having an axial line and a side surface, the nozzle having an ejection port; and ejecting a jet of the processing liquid containing a cavity along an ejection direction, the ejection direction being inclined with respect to the axial line as viewed from perpendicular to the axial line and being inclined with respect to a normal line from the ejection port to the side surface as viewed along the axial line.

### CROSS-REFERENCE TO RELATED APPLICATIONS

This application claims the benefit of priority to Japanese Patent Application No. 2023-098400, filed on Jun. 15, 2024, the entire contents of which are hereby incorporated by reference.

### BACKGROUND

### 1. Technical Field

The present invention relates to a cavitation processing method for performing a cavitation processing on a surface of a workpiece.

### 2. Description of the Background

Conventionally, a cavitation processing is performed on a workpiece made of metal (Japanese Patent No. 6872929). In the cavitation processing, a jet of a fluid containing a cavity (bubble) is caused to collide with the workpiece to process the surface of the workpiece by an impact force when the cavity collapses. The cavitation processing enables to apply compressive residual stress to the surface of the workpiece.

### BRIEF SUMMARY

The workpiece to be performed by the cavitation processing has various shape and size. In order to perform an appropriate cavitation processing, it is necessary to cause a jet to collide with the surface of the workpiece by an appropriate method according to the conditions of the workpiece.

An object of the present invention is to provide a cavitation processing method for performing the cavitation processing on a side surface of an workpiece hole.

One or more aspects of the present invention provides a cavitation processing method, including:
immersing a workpiece and a nozzle in a processing liquid, the workpiece having a target hole having an axial line and a side surface, the nozzle having an ejection port; and
ejecting a jet of the processing liquid containing a cavity along an ejection direction, the ejection direction being inclined with respect to the axial line as viewed from perpendicular to the axial line and being inclined with respect to a normal line from the ejection port to the side surface as viewed along the axial line.

The substantially circular shape includes, in addition to a circular shape, a shape that approximates a circular shape, such as an elliptical shape or a regular polygon having an obtuse internal angle. The shape may be a shape having a deformation such as a slight unevenness or distortion. The shape of the cross-section of the target hole is, for example, a circle, an oval, a regular decagon, a regular icosagon, a shape that shrinks the regular polygon of ten or more sides in one direction of the vertical or horizontal. The cross-sectional shape of the target hole may be deformed along the direction of the axis. For example, the cross-section of the target hole may partially be reduced along the direction of the axis. Preferably, the cross-sectional shape of the target hole varies continuously along the direction of the axis.

The axial line of the target hole passes, for example, through the center of gravity of the cross section. The target hole may be manufactured by additive manufacturing.

The jet travels along the side surface, and the cavitation processing is performed on the region of the side surface through which the jet passes.

In the cavitation processing, both the workpiece and the nozzle are immersed in the processing liquid stored in the tank. In the processing liquid, the jet of the processing liquid is ejected from the nozzle toward the workpiece. The processing liquid is, for example, water. The processing liquid may be a mixture of water and an abrasive. The abrasive material may be clouded with the processing liquid stored in the tank.

The workpiece is made of metal. The metal constituting the workpiece is, for example, a heat-resistant alloy, an aluminum alloy, a magnesium alloy, titanium, a titanium alloy, or steel. The workpiece is, for example, a mechanical component, a medical device component, or a medical device. The mechanical component is, for example, a pipe, a valve, a pipe fitting, an aerospace component. The medical device is, for example, a surgical implant. The aerospace component is, for example, an aircraft engine component, other aircraft component, a rocket engine component, a spacecraft component, a satellite component, a pipe for rocket. The workpiece may be manufactured by additive manufacturing.

The target hole of the workpiece may be a hole having a bottom surface. The target hole may be a hole that penetrates the workpiece. The target hole may be a linearly extending hole having a linear axis. The target hole may be a bent hole having a curved axis.

The target hole may extend in the vertical direction. The target hole may extend in the horizontal direction. The target hole may extend in an inclined direction with respect to the vertical direction or the horizontal direction. When the target hole is bent to extend, the direction of the axis at the opening of the target hole may be any direction. The target hole may be a hole having no branch. The target hole may be a hole having a branch. The inner diameter of the target hole is, for example, 24 mm or larger.

The ejection port diameter of the nozzle is, for example, 0.5 mm to 3 mm. The ejection pressure of the jet is, for example, 10 MPa to 200 MPa.

The inclination angle of the jet in the ejection direction with respect to the axial line is, for example, 5 degrees or more and less than 90 degrees, and preferably 15 degrees to 75 degrees.

The nozzle may move along the axis. For example, the nozzle may move from the upstream side to the downstream side of the flow of the jet. The nozzle may move from the downstream side to the upstream side of the flow of the jet. The line parallel to the axial line also includes the axial line itself. That is, the nozzle may rotate about the axial line. The nozzle may rotate about an axis different from and parallel to the axial line. The nozzle may be inserted into the target hole from the beginning of the cavitation processing. The nozzle may be positioned outside the target hole at the beginning of the cavitation processing, and then moved and inserted into the target hole.

The cavitation processing may be performed on the entire side surface of the target hole. The cavitation processing may be performed on a part of the side surface of the target hole.

The cavitation processing method according to the present invention enables to perform the cavitation processing on the side surface of the workpiece hole.

### BRIEF DESCRIPTION OF DRAWINGS

FIG. 1 shows a cavitation processing apparatus according to a first embodiment.

FIG. 2 shows an axial sectional view of a nozzle portion and a workpiece according to the first embodiment.

FIG. 3 is a cross-sectional view taken along line III-III in FIG. 2.

FIG. 4 is an explanatory view of a region to be cavitated according to the first embodiment.

FIG. 5 is an explanatory view of a strip region.

FIG. 6A is an exemplary view of the cavitation processing according to the first embodiment.

FIG. 6B is an explanatory view of a nozzle rotation according to the first embodiment.

FIG. 7A is an exemplary view of the cavitation processing according to the first embodiment.

FIG. 7B is an explanatory view of a nozzle movement according to the first embodiment.

FIG. 8A is an exemplary view of the cavitation processing according to the first embodiment.

FIG. 8B is an explanatory view of a nozzle movement according to the first embodiment.

FIG. 9 is an axial sectional view of a workpiece according to a second embodiment.

### DETAILED DESCRIPTION

### First Embodiment

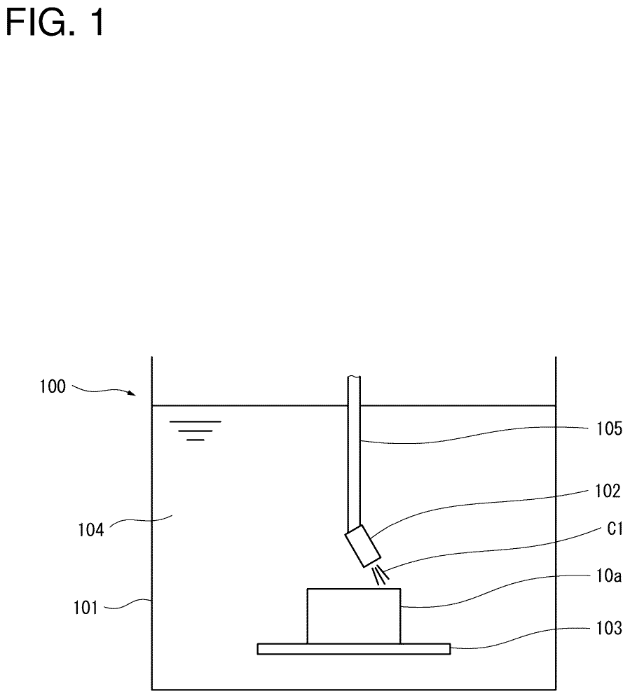

A cavitation processing apparatus used for a cavitation processing method according to a first embodiment will be described. As shown in FIG. 1, the cavitation processing apparatus 100 includes a tank 101, a nozzle 102, a mounting table 103, a supply pipe 105, and a high-pressure fluid supply source (not shown). The cavitation processing apparatus 100 performs a cavitation processing on a workpiece 10a.

The tank 101 stores a processing liquid 104. The processing liquid 104 is, for example, water. The tank 101 may include a device for circulating the stored processing liquid 104.

The supply pipe 105 is, for example, a straight pipe extending in a vertical direction. The processing liquid 104 supplied from the high-pressure fluid supply source passes through the inside of the supply pipe 105.

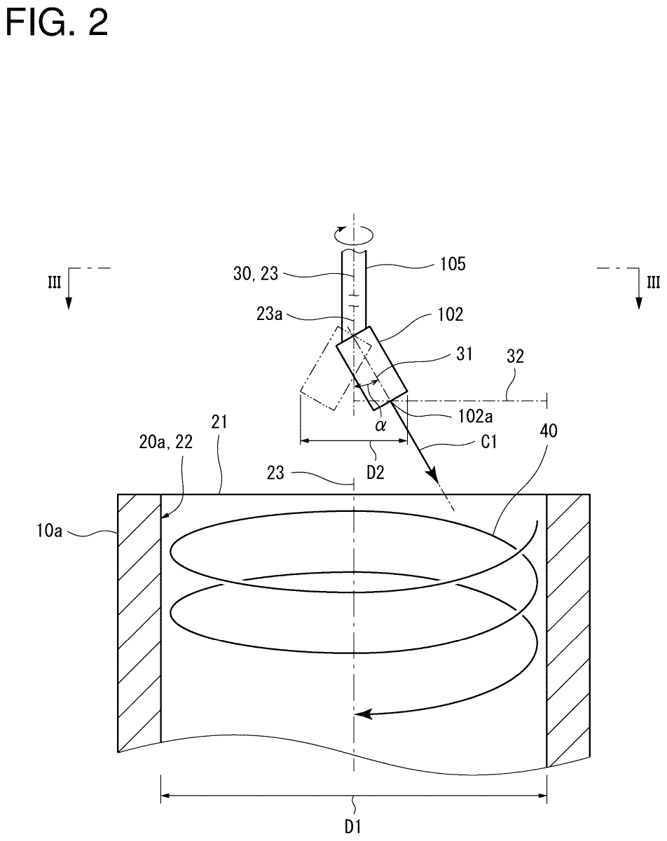

The nozzle 102 is connected to a lower end portion of the supply pipe 105. As shown in FIG. 2, the nozzle 102 has an ejection port 102a. The nozzle 102 ejects a jet C1 of the processing liquid 104 from the ejection port 102a. The ejection direction of the jet C1 will be described later. The processing liquid 104 is supplied from the high-pressure fluid source through supply pipe 105 to the nozzle 102. The jet C1 contains many cavities. The nozzle 102 and the supply pipe 105 can move in three axial directions, that is, in a horizontal direction (a front-rear direction and a left-right direction) and the vertical direction. The nozzle 102 rotates integrally with the supply pipe 105. The nozzle 102 rotates about a rotation axis 30. The central axis of the supply pipe 105 may coincide with the rotation axis 30. A control device (not shown) controls an ejection velocity (pressure) of the jet C1 and the three-axial movements and rotations of the nozzle 102 or the supply pipe 105. The nozzle 102 has a nozzle diameter (inner diameter) of, for example, 0.5 mm to 3 mm.

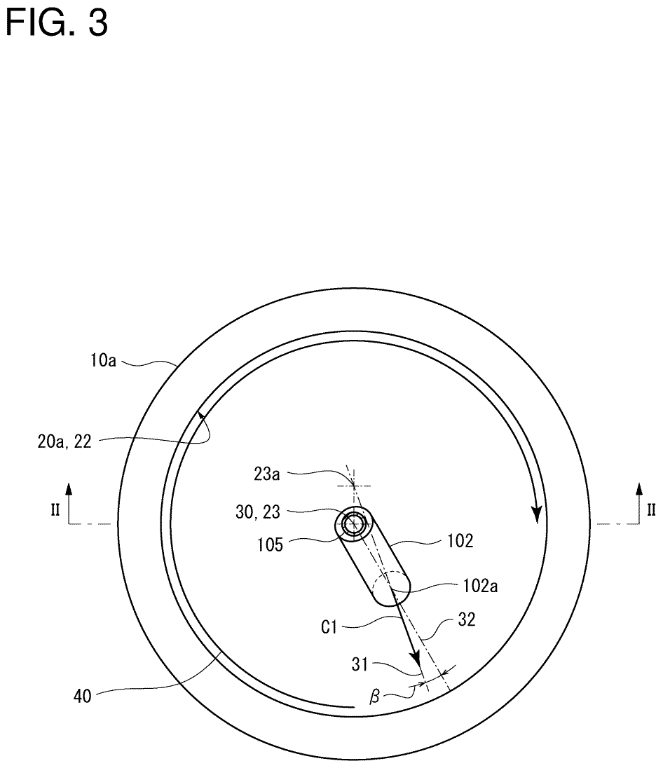

As shown in FIGS. 2 and 3, in the cavitation processing process according to the present embodiment, the workpiece 10a is a straight pipe. FIG. 2 is a sectional view taken along line II-II in FIG. 3. The workpiece 10a has a single target hole 20a. The target hole 20a has an axial line 23. The axial line 23 of the target hole 20a is also an axial line of the workpiece 10a. The target hole 20a, which is circular in cross section, extends linearly. That is, the axial line 23 of the target hole 20a is a straight line. The axial line 23 of the target hole 20a coincides with the center axis of the target hole 20a.

The target hole 20a has openings at both ends. A first opening 21 of the target hole 20a is located upward. A second opening (not shown) of the target hole 20a is located downward. The target hole 20a has a cylindrical side surface 22. The target hole 20a has an inner diameter D1 larger than an outer diameter of the nozzle 102. The inner diameter D1 of the target hole 20a is larger than a rotation diameter D2 of the nozzle 102. The nozzle 102 thus can be inserted into the target hole 20a to be rotated. The inner diameter of the target hole 20a may not change along the axial line 23. The inner diameter of the target hole 20a may vary along the axial line 23.

In the cavitation processing method according to the present embodiment, the rotation axis 30 of the nozzle 102 is aligned with the axial line 23 of the target hole 20a. Here, a straight line that is parallel to an ejection direction of the jet C1 and passes through the center of the ejection port 102a is referred to as a jet center line 31. As shown in FIG. 2, the jet center line 31 is inclined with respect to the axial line 23 (the rotation axis 30 of the nozzle 102) of the target hole 20a. At this time, the acute angle formed by the jet center line 31 and the axial line 23 is defined as a first inclination angle α. That is, the ejection direction of the jet C1 is inclined by the first inclination angle α with respect to the axial line 23 of the target hole 20a. The first inclination angle α is, for example, 5 degrees or more and less than 90 degrees, and preferably 15 degrees to 75 degrees. It should be noted that the jet center line 31 and the axial line 23 do not intersect each other and are in a torsional position. Therefore, the first inclination angle α is defined as an angle formed by the parallel lines of the jet center line 31 and the axial line 23 which intersect at any point.

As shown in FIGS. 2 and 3, the jet center line 31 intersects a parallel-line 23a of the axial line 23. In FIG. 2, the parallel-line 23a is located at the rear of the axial line 23 in a direction perpendicular to the plane of the drawing. The jet center line 31 is inclined with respect to the plane of FIG. 2. Therefore, in practice, the first inclination angle α is an angle on a plane inclined with respect to the plane of FIG. 2.

As shown in FIG. 3, when viewed from the axial line 23, the jet center line 31 intersects a normal line 32 from the ejection port 102a to the side surface 22 of the target hole 20a. The normal line 32 is a straight line passing through the center of the ejection port 102a and perpendicular to a tangent line of the side surface 22. The jet center line 31 is inclined with respect to the normal line 32. At this time, the acute angle formed by the jet center line 31 and the normal line 32 is defined as a second inclination angle β. That is, the ejection direction of the jet C1 is inclined by the second inclination angle β with respect to the normal line 32 from the ejection port 102a to the side surface 22 of the target hole 20a. The second inclination angle β is, for example, 1 degree or more and 10 degrees or less.

As shown in FIG. 1, the mounting table 103 places and fixes the workpiece 10a. The mounting table 103 fixes the workpiece 10a with a fastener such as a bolt or a clamp, or fixes the workpiece 10a by sandwiching the workpiece. The mounting table 103 is movable in the vertical direction. The workpiece 10a thus can be taken in and out of the tank 101. The control device controls the vertical movement of the mounting table 103.

The cavitation processing apparatus 100 can eject the jet C1 at any position in the workpiece 10a from any distance.

In the present embodiment, the entire side surface 22 of the target hole 20a is cavitation processed. Thus, the effect of cavitation processing is applied to the entire side surface 22 of the target hole 20a.

The steps of the cavitation processing method according to the present embodiment performed by the cavitation processing apparatus 100 are as follows.

First, the processing liquid 104 is stored in the tank 101. The amount of the processing liquid 104 to be stored is an amount that allows the workpiece 10a to be immersed in sufficient depth. The sufficient depth is, for example, 300 mm to 500 mm. At this time, the nozzle 102 and the mounting table 103 are positioned above the liquid level of the processing liquid 104.

Next, the workpiece 10a is placed and fixed on the mounting table 103. The workpiece 10a is fixed in a posture in which the first opening 21 of the target hole 20a faces upward.

Next, the mounting table 103 is moved downward to immerse the workpiece 10a and the mounting table 103 in the processing liquid 104 stored in the tank 101.

Next, the nozzle 102 is moved horizontally to position the nozzle 102 upward from the opening 21 of the target hole 20a. At this time, the rotation axis 30 of the nozzle 102 is aligned with the axial line 23 of the target hole 20a.

Next, the nozzle 102 is moved downward to immerse the nozzle 102 in the processing liquid 104 stored in the tank 101. The distance between the nozzle 102 and the opening 21 of the target hole 20a is set to a distance suitable for the cavitation processing. The opening 21 is an upper end portion of a region where the cavitation processing is performed. The distance suitable for the cavitation processing is, for example, a distance of about 40 to 100 times an opening diameter of the nozzle 102. For example, if the nozzle 102 has an opening diameter of 1 mm, the distance between the nozzle 102 and the opening 21 is preferably 40 mm to 100 mm.

The high-pressure fluid source is then activated to eject the jet C1 from the nozzle 102. The jet C1 enters into the target hole 20a through the opening 21 of the target hole 20a.

Next, the nozzle 102 is rotated about the rotation axis 30 (the axial line 23 of the target hole 20a) as needed. Further, the nozzle 102 is moved downward to be inserted into the target hole 20a as needed.

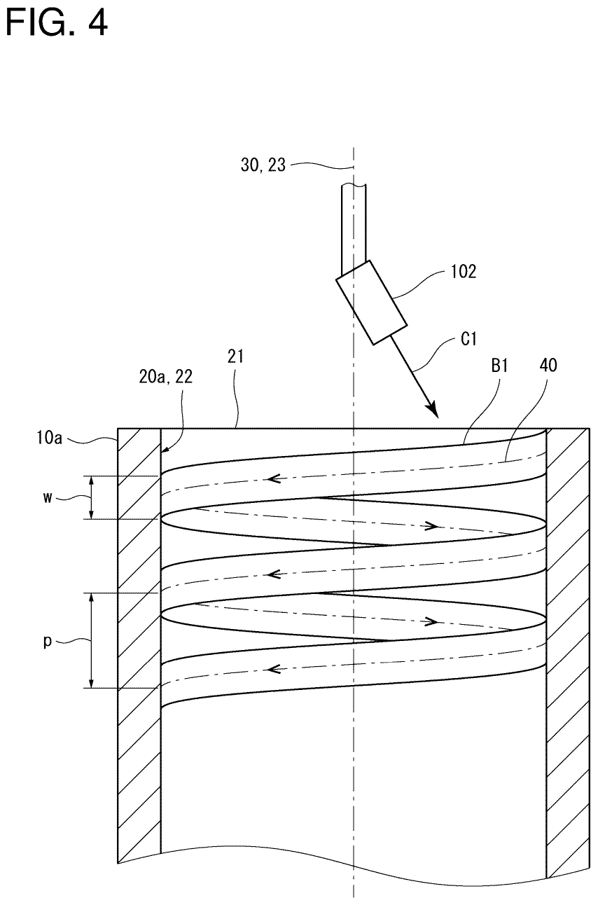

As shown in FIGS. 2 and 3, the jet C1 ejected in the above-described direction travels while spirally rotating inside the target hole 20a. A trajectory 40 of the jet C1 is helical about the axial line 23 of the target hole 20a and along the side surface 22. The trajectory 40 of the jet C1 is a line drawn by the center of the jet C1 on the side surface 22 as the jet C1 travels. As shown in FIG. 4, the cavitation processing is performed, on the side surface 22, in a spiral strip region B1 having a predetermined width centered on the trajectory 40 of the jet C1.

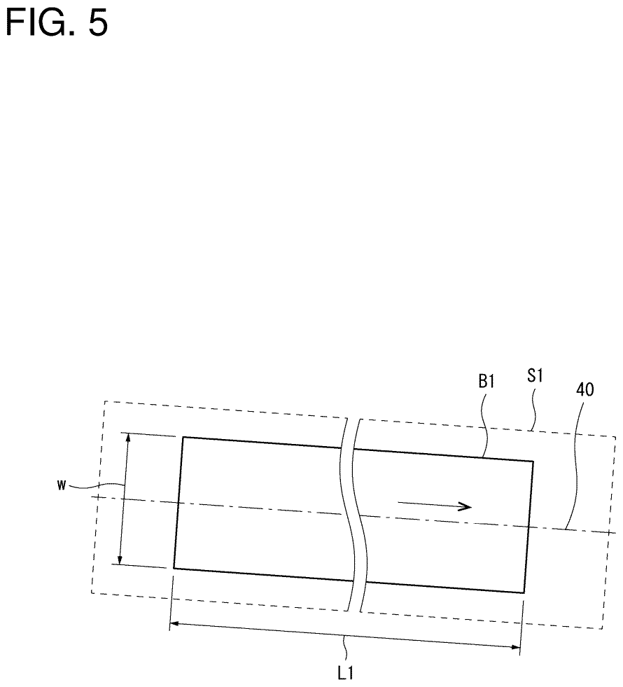

Note that the shapes of the strip region B1 vary depending on various conditions. The various conditions are, for example, the ejection direction of the jet C1 (first inclination angle α, second inclination angle β), the diameter of the target hole 20a, the ejection velocity (pressure) of the jet C1, and the like. As shown in FIGS. 4 and 5, the shapes of the strip region B1 include, for example, a length L1 along the trajectory 40, a width w around the trajectory 40, a pitch p of a spiral drawn by the trajectory 40, and the like. As the jet C1 travels, the cavities contained in the jet C1 collapse. The length L1 of the strip region B1 is thus limited.

Note that, in the cavitation processing, the strength of the cavitation processing changes according to the distance along the trajectory 40 from the nozzle 102 as the cavity grows and collapses in the jet C1. The strength of the cavitation processing is, for example, the strength of the compressive residual stress applied, or the density or depth of the dimples formed on the surface. When the cavitation processing is performed, the strongest processing is performed at the point where the distance from the nozzle 102 is the most suitable distance, and the strength of the processing becomes weaker as the distance from the point increases. Similarly, in the direction orthogonal to the trajectory 40, the strength of the processing becomes weaker as the distance from the trajectory 40 increases. Here, a region where a processing of sufficient strength is performed is referred to as the strip region B1. As shown in FIG. 5, there is a peripheral region S1 in which a processing having insufficient strength is performed around the strip region B1. In the drawings other than FIG. 5, the peripheral region S1 is not shown, and only the strip region B1 is shown. The strength of the cavitation processing is not uniform inside the strip region B1, and there is a processing unevenness in accordance with the distance from the nozzle 102.

In some cases, the cavitation processing is performed on the entire side surface 22 only by ejecting the jet C1 from the nozzle 102. This is the case, for example, where the vertical length of the target hole 20a is sufficiently short or where the diameter of the target hole 20a is sufficiently short.

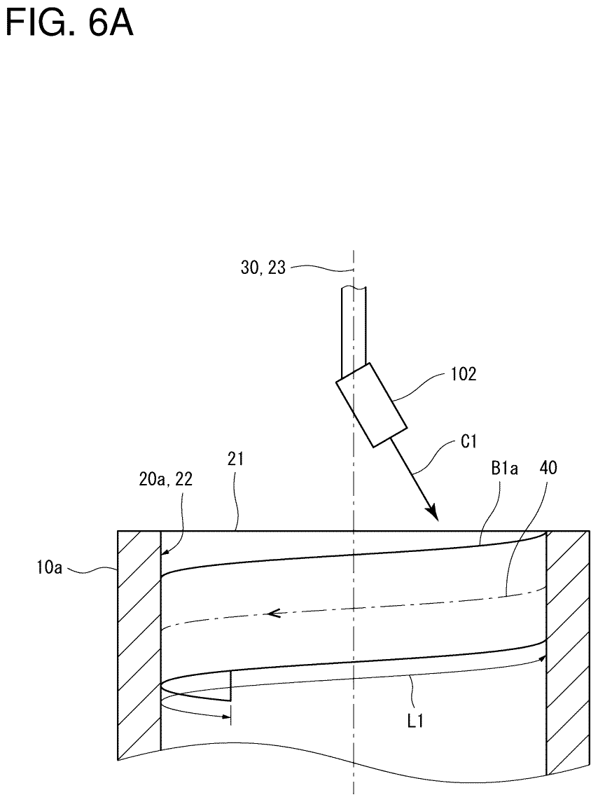

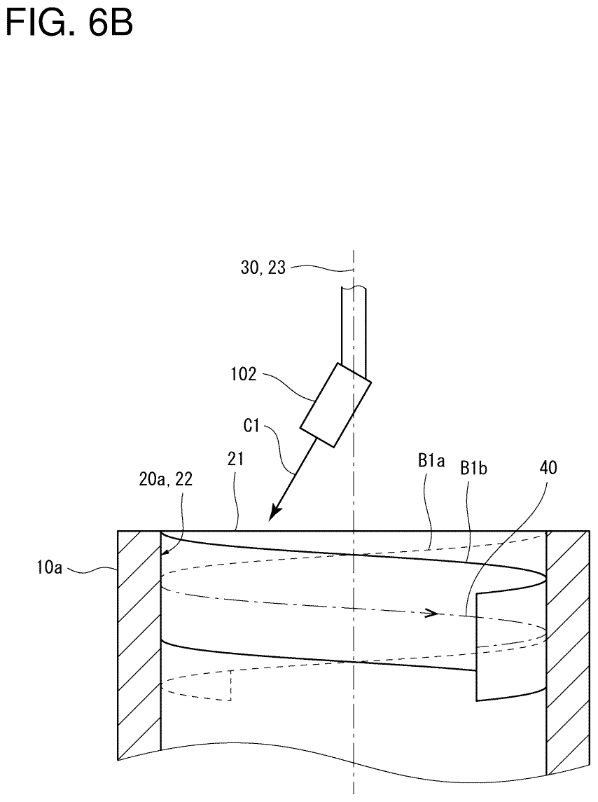

On the other hand, depending on the condition, the cavitation processing is not performed on the entire side surface 22 only by ejecting the jet C1 from the nozzle 102. For example, as shown in FIG. 6A, the length L1 of the strip region B1a is shorter than one circumference of the spiral, and the cavitation processing may be performed only on a part of the side surface 22 in the circumferential direction. For example, the target hole 20a has a large diameter, and the length L1 of the strip region B1a is shorter than one circumference of the trajectory 40. In this case, the nozzle 102 is rotated about the axial line 23 of the target hole 20a while the jet C1 is ejected. As a result, as shown in FIG. 6B, the cavitation processing is performed on a new strip region B1b. The new strip region B1b is a region different from the strip region B1a before rotating the nozzle 102 in accordance with the direction of the nozzle 102 (the ejection direction of the jet C1). As described above, the cavitation processing is performed on the entire surface (the entire circumference in the circumferential direction) of the side surface 22 by rotating the nozzle 102.

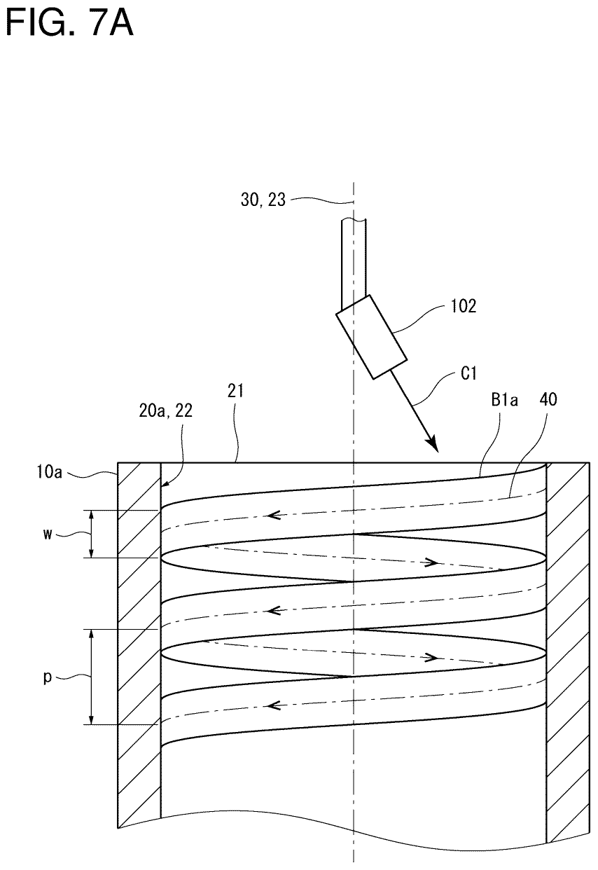

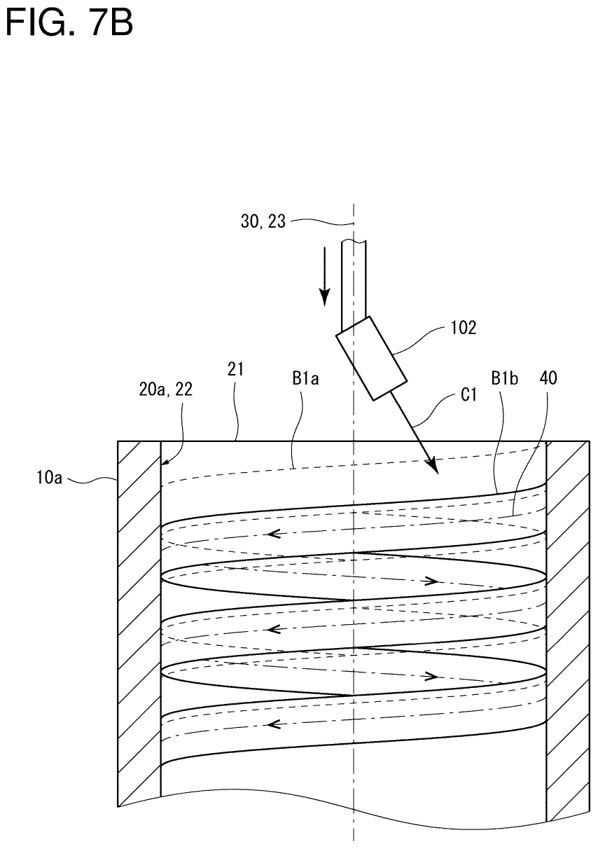

As shown in FIG. 7A, when the strip region B1a at a certain point is separated from the strip region B1a at a point one circumference along the side surface 22, the cavitation processing may be performed only partially. For example, this is the case where the pitch p of the spiral drawn by the trajectory 40 is longer than the width w of the strip region B1a. In this case, the nozzle 102 is moved downward while the jet C1 is ejected. That is, the nozzle 102 is moved along the axial line 23 of the target hole 20a. As a result, as shown in FIG. 7B, the cavitation processing is performed on the new strip region B1b. The new strip region B1b is a region different from the strip region B1a before the nozzle 102 is moved in accordance with the vertical position of the nozzle 102. As described above, the cavitation processing is performed on the entire side surface 22 by moving the nozzle 102. In this case, the cavitation processing may be performed on the entire side surface 22 by rotating the nozzle 102.

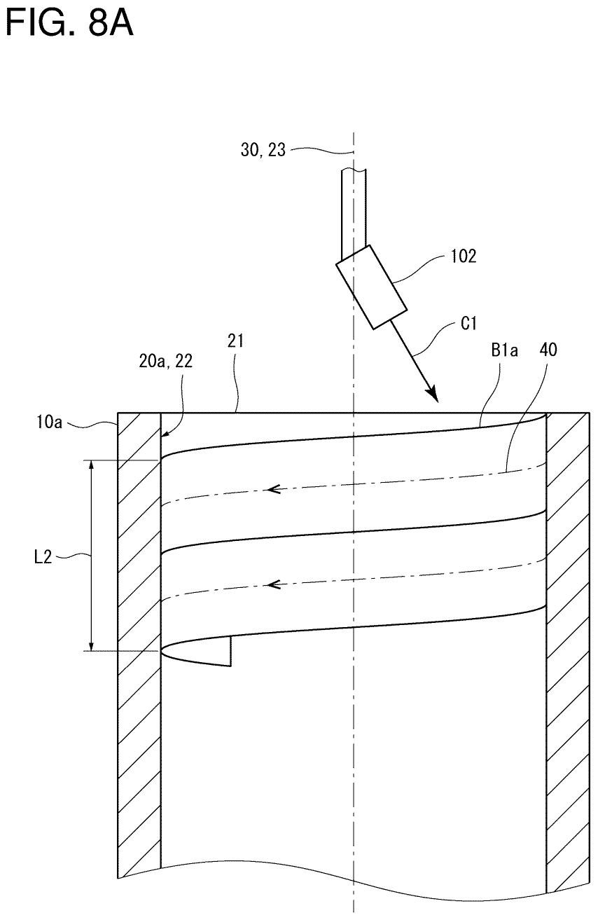

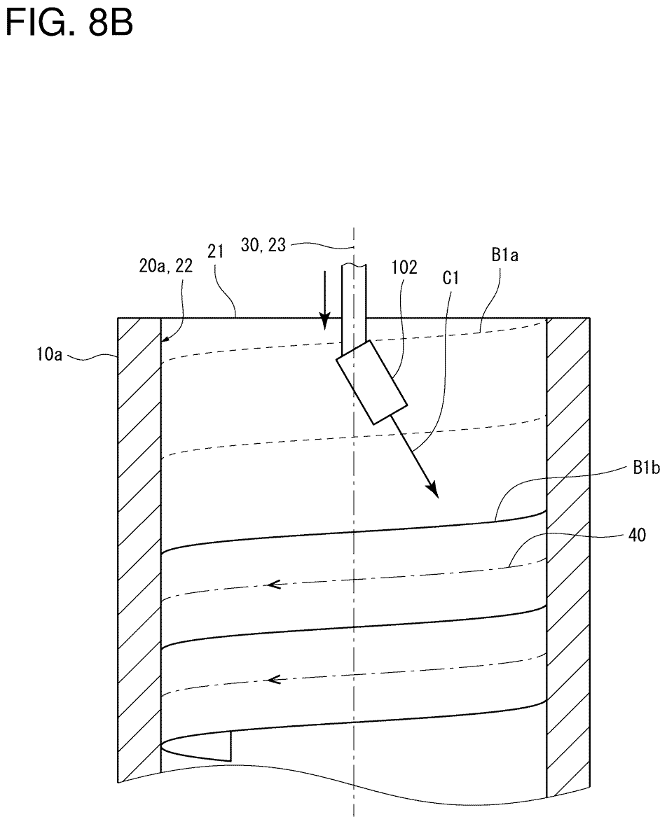

As shown in FIG. 8A, when the length L1 of the strip region B1a is short, and the cavitation processing may be performed only on a part of the upper side of the side surface 22. This is the case, for example, where the vertical length of the target hole 20a is longer than the length L2 in the direction of the axial line 23 when the strip region B1 is wound along the trajectory 40. In this case, the nozzle 102 is moved downward while the jet C1 is ejected. At this time, the nozzle 102 may be inserted into the target hole 20a. As a result, as shown in FIG. 8B, the cavitation processing is performed on the new strip region B1b. The new strip region B1b is a region different from the strip region B1a before the nozzle 102 is moved in accordance with the vertical position of the nozzle 102. As described above, the cavitation processing is performed on the entire side surface 22 by moving the nozzle 102.

When the above-described various conditions are overlapped, the nozzle 102 may be rotated and moved simultaneously. Further, the nozzle 102 may be rotated or moved regardless of various conditions as described above.

As described above, the cavitation processing is performed on the side surface 22 by ejecting the jet C1 from the nozzle 102, and by rotating or moving the nozzle 102 as needed. Here, when the jet C1 is ejected in a direction perpendicular to the axial line 23 of the target hole 20a, the jet C1 that has collided with the side surface 22 travels around the side surface 22 one time, and returns to the first collision point. Then, the jet C1 ejected from the nozzle 102 collides with the returned jet C1, and the cavitation processing at that point is hindered. In the present embodiment, the jet C1 travels while spirally rotating. The spiraling jet C1 and the jet C1 colliding with the side surface 22 do not collide with each other. The cavitation processing by the jet C1 is thus not hindered.

The circumferential process unevenness inside the strip region B1 is reduced by rotating the nozzle 102. The processing unevenness in the direction of the axial line 23 inside the strip region B1 is reduced by moving the nozzle 102 along the axial line 23.

The order of the steps of the cavitation processing method according to the present embodiment is not limited to the above-described order. For example, the processing liquid 104 may be stored in the tank 101 after the mounting table 103 or the nozzle 102 is moved. The nozzle 102 may be moved in the downward direction and then moved in the horizontal direction. The nozzle 102 may be moved simultaneously in the horizontal direction and the downward direction.

### Second Embodiment

The cavitation processing method according to a second embodiment will be described. Also in the present embodiment, the cavitation processing apparatus 100 substantially the same as that of the first embodiment is used.

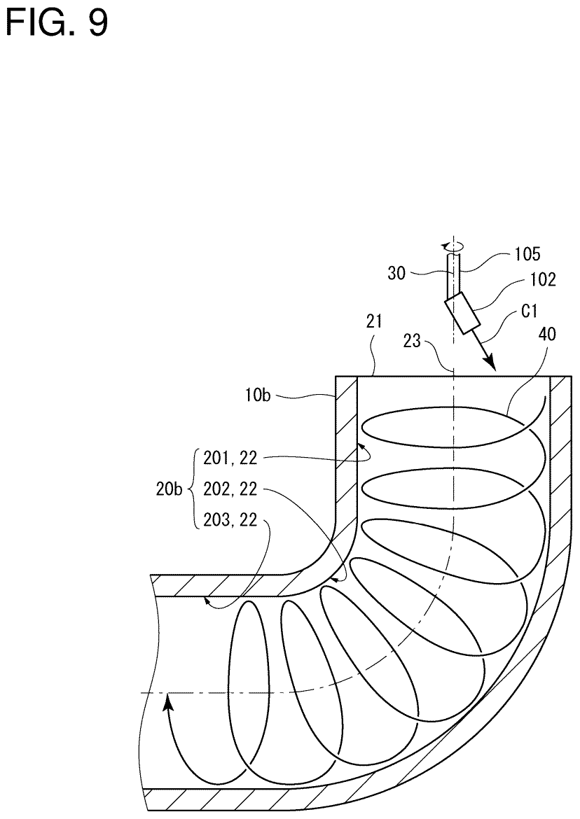

As shown in FIG. 9, in the cavitation processing method according to the present embodiment, a workpiece 10b is a bent pipe. The workpiece 10b has a single target hole 20b. The target hole 20b has an axial line 23. The target hole 20b, which is circular in cross section, has a straight extending portion and a bent extending portion. The target hole 20b includes an upstream straight portion 201, a bent portion 202, and a downstream straight portion 203. The upstream straight portion 201 extends in the vertical direction. The bent portion 202 is bent horizontally from a lower end of the upstream straight portion 201. The downstream straight portion 203 extends in the horizontal direction from a distal end of the bent portion 202. The axial line 23 of the target hole 20b has a straight portion and a bent portion, similar to the target hole 20b.

The target hole 20b has openings at both ends. The target hole 20b has a first opening 21 in the upstream straight portion 201. The first opening 21 opens upward. The target hole 20b has a second opening (not shown) in the downstream straight portion 203. The second opening opens horizontally.

The target hole 20b has a cylindrical side surface 22. The target hole 20b has an inner diameter larger than an outer diameter of the nozzle 102. The inner diameter of the target hole 20b is larger than a rotational diameter of the nozzle 102. The nozzle 102 thus can be inserted into the target hole 20b to be rotated. The target hole 20b may have an inner diameter that does not change along the axial line 23. The target hole 20b may have an inner diameter that varies along the axial line 23.

In the present embodiment, the cavitation processing is performed on the entire side surface 22 of the target hole 20b.

The step of the cavitation processing method according to the present embodiment is substantially the same as the step of the cavitation processing method of the first embodiment. The cavitation processing is performed on the side surface 22 by ejecting the jet C1 from the nozzle 102, and by rotating or moving the nozzle 102 as needed. The trajectory 40 of the jet C1 is spiral about the axial line 23 of the target hole 20b and along the side surface 22. Also in the bent portion 202, the jet C1 travels while spiraling along the side surface 22. Note that the supply pipe 105 may be bendable, and the nozzle 102 may move along the bent axial line 23 in the bent portion 202.

The present invention is not limited to the above-described embodiments, and various modifications can be made without departing from the gist of the present invention, and all technical matters included in the technical idea described in the claims are the subject of the present invention. While the above embodiments have been shown by way of example, those skilled in the art will recognize that various alternatives, modifications, variations, and improvements can be made from the disclosure herein, which fall within the scope of the appended claims.

### REFERENCE SIGNS LIST

10 a, 10b Workpiece
20a, 20b Target hole
22 Side surface
23 Axial line
32 Normal line
102 Nozzle
102a Ejection port
104 Processing liquid
C1 Jet

What is claimed is:

1. A cavitation processing method, comprising:
immersing a workpiece and a nozzle in a processing liquid, the workpiece having a target hole having an axial line and a side surface, the nozzle having an ejection port; and
ejecting a jet of the processing liquid containing a cavity along an ejection direction, the ejection direction being inclined with respect to the axial line as viewed from perpendicular to the axial line and being inclined with respect to a normal line from the ejection port to the side surface as viewed along the axial line.

2. The cavitation processing method according to claim 1, wherein
the target hole has a substantially circular cross-section.

3. The cavitation processing method according to claim 1, further comprising:
rotating the nozzle about an axis parallel to the axial line.

4. The cavitation processing method according to claim 1, further comprising:
moving the nozzle along the axial line.

5. The cavitation processing method according to claim 1, further comprising:
inserting the nozzle into the target hole.

6. The cavitation processing method according to claim 1, wherein
an inclination angle of the ejection direction with respect to the axial line is 5 degrees or more and less than 90 degrees.

7. The cavitation processing method according to claim 1, wherein
an inclination angle of the ejection direction with respect to the normal line as viewed along the axial line is 1 degree or more and 10 degrees or less.

8. The cavitation processing method according to claim 1, further comprising:
making the jet to travel along the side surface for performing a cavitation processing on a region of the side surface on which the jet has passed.

9. The cavitation processing method according to claim 2, further comprising:
rotating the nozzle about an axis parallel to the axial line.

10. The cavitation processing method according to claim 2, further comprising:
moving the nozzle along the axial line.

11. The cavitation processing method according to claim 3, further comprising:
moving the nozzle along the axial line.

12. The cavitation processing method according to claim 2, further comprising:
inserting the nozzle into the target hole.

13. The cavitation processing method according to claim 3, further comprising:
inserting the nozzle into the target hole.

14. The cavitation processing method according to claim 4, further comprising:
inserting the nozzle into the target hole.

15. The cavitation processing method according to claim 2, wherein
an inclination angle of the ejection direction with respect to the axial line is 5 degrees or more and less than 90 degrees.

16. The cavitation processing method according to claim 3, wherein
an inclination angle of the ejection direction with respect to the axial line is 5 degrees or more and less than 90 degrees.

17. The cavitation processing method according to claim 4, wherein
an inclination angle of the ejection direction with respect to the axial line is 5 degrees or more and less than 90 degrees.

18. The cavitation processing method according to claim 5, wherein
an inclination angle of the ejection direction with respect to the axial line is 5 degrees or more and less than 90 degrees.

19. The cavitation processing method according to claim 2, wherein
an inclination angle of the ejection direction with respect to the normal line as viewed along the axial line is 1 degree or more and 10 degrees or less.

20. The cavitation processing method according to claim 3, wherein
an inclination angle of the ejection direction with respect to the normal line as viewed along the axial line is 1 degree or more and 10 degrees or less.
